(19) United States
(12) Patent Application Publication
(10) Pub. No.: US 2005/0065947 A1
(43) Pub. Date: Mar. 24, 2005

(54) Thesaurus maintaining system and method

(76) Inventors: Yang He, Shenzhen (CN); Chien-Fa Yeh, Tu-Chen (TW); Chung-I Lee, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/945,804

(22) Filed: Sep. 20, 2004

(30) Foreign Application Priority Data
Sep. 19, 2003 (TW) 92125995

(51) Int. Cl. G06F 17/00

(52) U.S. Cl. 707/100

(57) ABSTRACT

A thesaurus maintaining system includes an application server (2), a plurality of client computers (1) and a database (3) linking to the application server through a communication means (4). The application server includes a synonym group classification module (20) for producing libraries of synonym groups in order to provide a host of different categories for different synonym groups, and for permitting users to define and edit the categories; a synonym group importing module (21) for receiving synonym groups input by users, and for importing the received synonym groups to corresponding synonym group lists (30); a synonym group merging module (24) for merging all synonym groups containing a same word into a new synonym group; and a synonym group maintenance module (25) for adding, deleting and modifying synonyms and/or synonym groups, and for updating a synonym group index. A related thesaurus maintaining method is also provided.

### BACKGROUND OF THE INVENTION

1. Field of the Invention

The present invention relates generally to automated systems and methods for thesaurus generating, and particularly to a computerized thesaurus maintaining system and method which can store synonym groups according to user-defined categories.

2. Background of the Invention

With the increasing amount of information that is available to users via today's computer systems, efficient techniques for locating information are becoming essential. A conventional information retrieval method may not locate all of the appropriate information in the database that contains a given search term, because the corresponding term in the database is misspelled in some of the documents. Therefore many so-called “synonym generating” methods have been developed in order to ameliorate the problem. A synonym of a particular word refers to a word which has the same or a similar meaning as the particular word. A “word” represents an independent meaning, and may be comprised in a single word or a phrase containing two or more words. The synonym generating technique is particularly effective when matters related to a certain theme are to be retrieved from a large scale database without omission.

One kind of synonym generating technique is known as “stemming,” which essentially involves the reduction of words to their grammatical stems. Retrieval using the stemming technique is improved, because a search which uses one form of a word locates documents containing all of the different forms of that word. Ideally, the stemming technique is applied to all words that can take different forms, and accounts for every possible form of each word. However, the rules used to reduce each word to its grammatical stem typically apply to only one language. Therefore the technique can-not be employed in connection with documents containing the word in other languages. Further, the documents located are not limited to documents containing derivatives of grammatical stem, but may also include other unwanted documents containing words which randomly match the grammatical stem.

Another example of synonym generating is disclosed in U.S. Pat. No. 5,469,355 issued on Nov. 21 1995 and entitled Near-synonym Generating Method. The patent discloses a method for generating one or more near-synonyms of a target character string by retrieving a near-synonym file based on the target character string, wherein the near-synonym file hierarchically defines near-synonyms for one or a plurality of words. The method comprises the steps of: retrieving the near-synonym file using words which form the target character string as keys, and extracting near-synonyms which are defined for each word forming the target character string; forming a near-synonym group from each word forming the target character string and the corresponding near-synonyms so as to form a plurality of such near-synonym groups, and selecting the words or near-synonym groups from each of the near-synonym groups; and generating the near-synonyms of the target character string by combining the selected words or near-synonyms. However, the near-synonym groups are not systematically stored. Retrieving near-synonym groups relating to a given word requires mining of the whole database, which can be exceedingly time-consuming. This in turn prolongs the process of retrieving information associated with the given word.

Accordingly, it is desired to provide a system and method which can overcome the foregoing drawbacks.

### SUMMARY OF THE INVENTION

A main objective of the present invention is to provide a thesaurus maintaining system and method which is able to generate a thesaurus and maintain the thesaurus.

Another objective of the present invention is to provide a thesaurus maintaining system and method which can store synonym groups according to user-defined categories.

To achieve the above objectives, a thesaurus maintaining system in accordance with the present invention comprises an application server, a plurality of client computers and a database linking to the application server through a communication means. The application server comprises a synonym group classification module for producing libraries of synonym groups in order to provide a host of different categories for different synonym groups, and for permitting users to define and edit the categories; a synonym group importing module for receiving synonym groups input by users, and for importing the received synonym groups to corresponding synonym group lists; a synonym group merging module for merging all synonym groups containing a same word into a new synonym group; and a synonym group maintenance module for adding, deleting and/or modifying existing synonyms and/or synonym groups, and for updating the synonym group index. The database is for storing the categories and the thesaurus. Each client computer is programmed to provide an interactive user interface for users of the thesaurus maintaining system to input synonym groups.

Further, a thesaurus maintaining method in accordance with the present invention comprises the steps of: selecting a category for importing a synonym group; receiving a synonym group input by a user; determining whether any word in the received synonym group already exists in a synonym group list that corresponds to the selected category; importing the synonym group in the synonym group list that corresponds to the selected category if none of the words in the received synonym group can be found in the synonym group list; and adding, deleting and/or modifying existing synonyms and/or synonym groups.

Other objects, advantages and novel features of the present invention will be drawn from the following detailed description of a preferred embodiment thereof with the attached drawings in which:

### BRIEF DESCRIPTION OF THE DRAWINGS

FIG. 1 is a schematic diagram of hardware infrastructure of a thesaurus maintaining system according to the preferred embodiment of the present invention;

FIG. 2 is a schematic diagram of function modules of an application server of the thesaurus maintaining system of FIG. 1;

FIG. 3 is a flowchart of a preferred method for thesaurus maintaining according to the present invention, utilizing the thesaurus maintaining system of FIG. 1; and

FIG. 4 is a flowchart of a synonym group maintaining process of the thesaurus maintaining method according to the present invention.

### DETAILED DESCRIPTION OF THE INVENTION

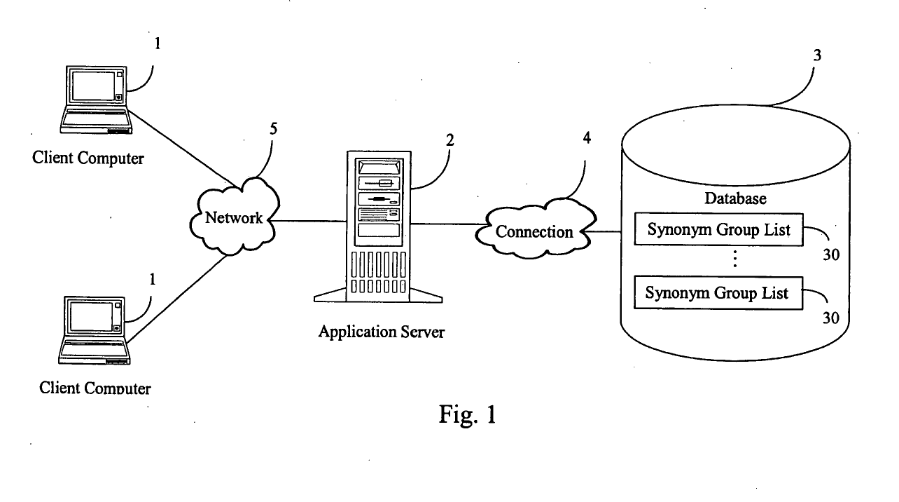

FIG. 1 is a schematic diagram of hardware configuration of a thesaurus maintaining system in accordance with the preferred embodiment of the present invention. In the preferred embodiment of the present invention, the thesaurus maintaining comprises thesaurus generating and synonym group maintaining. The thesaurus maintaining system comprises a plurality of client computers 1, an application server 2 and a database 3. Each client computer 1 is connected with the application server 2 through a network 5. The network 5 may be any suitable communication architecture required by the thesaurus maintaining system, such as a local area network or a wide area network.

Each client computer 1 is programmed to provide an interactive user interface for users of the thesaurus maintaining system to input synonym groups. A synonym group is a set of synonyms that correspond to an index word. A synonym is a word having the same or nearly the same meaning as another word or other words. In the preferred embodiment of the present invention, a “word” represents an independent meaning, and may be comprised in a single word or a phrase containing two or more words. An original word is called an index word, which typically may have more than one synonym in any one language. The synonym may be in the same language as the index word, or may be in any other foreign language selected by a user. Preferably, a word may be contained in different synonym groups, which are organized into different categories. The categories for the synonym groups may be defined in any known manner; for example, by user defined classifications, according to different technical aspects, according to design or industry specific criteria, or according to other classification criteria. The synonym groups corresponding to a category may be separately stored in an accrued synonym group list, which can function as a dictionary, a glossary, a thesaurus or another analysis tool, any of which can be accessed and displayed by users. The synonym group list can be comprised in a Microsoft Excel file, and can be added to as needed. Synonyms in a same language are stored in a same column of the synonym group list. Every two adjacent synonyms are separated by a slash “/” if an index word has more than one synonym in a same language.

The application server 2 is provided to implement a variety of functions and operations such as importing, merging and displaying synonym groups, and adding, deleting and modifying synonyms and/or synonym groups. The application server 2 is connected with the database 3 via a connection 4. The connection 4 is a database connectivity, such as an ODBC (Open Database Connectivity) or a JDBC (Java Database Connectivity). The database 3 is provided for storing a host of synonym group lists 30. Each synonym group list 30 has a single synonym group index corresponding to a single category defined by users. A synonym group index is a list of index words of a synonym group list 30. All the synonym group lists 30 collectively form a thesaurus of different categories.

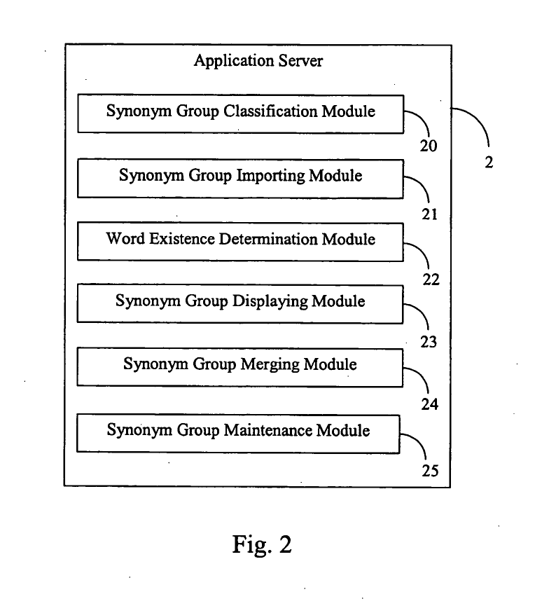

FIG. 2 is a schematic diagram showing main function modules of the application server 2. The application server 2 comprises a synonym group classification module 20, a synonym group importing module 21, a word existence determination module 22, a synonym group displaying module 23, a synonym group merging module 24, and a synonym group maintenance module 25.

The synonym group classification module 20 is programmed to produce libraries of synonym groups in order to provide a host of different categories for different synonym groups, and to permit users to further define or edit the categories. The synonym group importing module 21 is used for receiving synonym groups input by users via any of the client computers 1, and for importing the received synonym groups to a synonym group list 30 corresponding to a selected category. The word existence determination module 22 is programmed to determine whether any word in a received synonym group already exists in the synonym group list 30 corresponding to a selected category. The synonym group displaying module 23 is used to display synonym group indexes, select an index word from a synonym group index, and to display all synonym groups containing the selected index word and a corresponding category of each synonym group simultaneously. The synonym group merging module 24 is provided to merge all synonym groups containing a same word into a new synonym group, and to delete one or more of the synonym groups containing the same word after merging. The synonym group maintenance module 25 is for adding, deleting and modifying existing synonyms and/or synonym groups stored in a synonym group list 30, and for updating synonym group indexes. An existing synonym means a synonym that already exists in the thesaurus. An existing synonym group means a synonym group that already exists in the thesaurus.

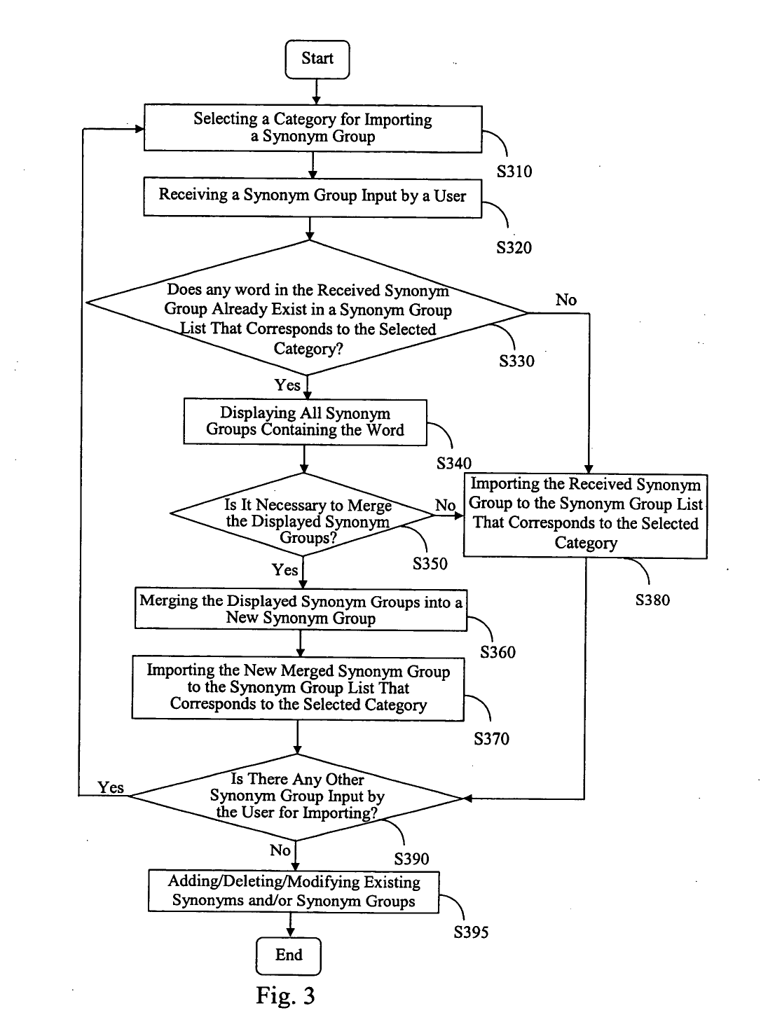

FIG. 3 is a flowchart of a preferred thesaurus maintaining method in accordance with the present invention. In step S310, the synonym group classification module 20 selects a category for importing a synonym group from the synonym group lists 30 stored in the database 3. A user can define or edit the categories as needed. In step S320, the synonym group importing module 21 receives a synonym group input by a user via a client computer 1. In step S330, the word existence determination module 22 determines whether any word in the received synonym group already exists in the synonym group list 30 that corresponds to the selected category. If none of the words in the received synonym group can be found in the synonym group list 30, the procedure goes directly to step S380 described below. If any word in the received synonym group already exists in the synonym group list 30, in step S340, the synonym group displaying module 23 displays all synonym groups containing the word on the screen of the client computer 1. Then in step S350, the synonym group merging module 24 determines whether it is necessary to merge the displayed synonym groups into a new synonym group. If it is not necessary to merge the displayed synonym groups into a new synonym group, the procedure goes to step S380. In step S380, the synonym group importing module 21 imports the received synonym group to the synonym group list 30 that corresponds to the selected category, whereupon the procedure goes to step S390 described below. If it is necessary to merge the displayed synonym groups into a new synonym group, in step S360, the synonym group merging module 24 selects an index word from the displayed synonym groups, merges the displayed synonym groups into a new synonym group, and deletes one or more of the displayed synonym groups after merging. Then in step S370, the synonym group importing module 21 imports the new merged synonym group to the synonym group list 30 that corresponds to the selected category, whereupon the procedure goes to step S390. In step S390, the synonym group importing module 21 determines whether there is any other synonym group input by the user for importing. If there is any other synonym group for importing, the procedure returns to step S310. Otherwise, in step S395, the synonym group maintenance module 25 can also add, delete and/or modify existing synonyms and/or synonym groups. Afterward, the procedure is ended.

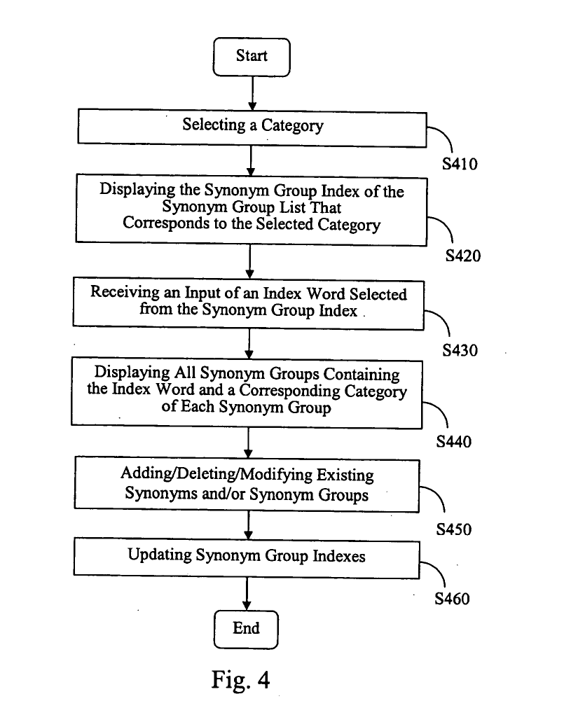

FIG. 4 is a flowchart detailing the process of synonym group maintaining of the thesaurus maintaining method according to the present invention. In step S410, the synonym group classification module 20 selects a category from the synonym group lists 30 stored in the database 3. In step S420, the synonym group displaying module 23 displays the synonym group index of the synonym group list 30 that corresponds to the selected category. In step S430, the synonym group displaying module 23 receives an input of an index word selected from the displayed synonym group index by a user. In step S440, the synonym group displaying module 23 displays all synonym groups containing the selected index word and a corresponding category of each synonym group simultaneously. In step S450, the synonym group maintenance module 25 can add, delete and modify any or all of the synonyms in the displayed synonym groups, and/or add, delete and modify any or all of the displayed synonym groups. Afterward, in step S460, the synonym group maintenance module 25 updates the synonym group indexes according to any such additions, deletions and/or modifications.

Although the present invention has been specifically described on the basis of a preferred embodiment and preferred methods, the invention is not to be construed as being limited thereto. Various changes or modifications may be made to said embodiment and methods without departing from the scope and spirit of the invention.

1. A thesaurus maintaining system comprising an application server, a plurality of client computers and a database linking to the application server through a communication means, wherein the application server comprises:
a synonym group classification module for producing libraries of synonym groups in order to provide a host of different categories for different synonym groups, and for permitting users to define and edit the categories;
a synonym group importing module for receiving synonym groups input by users, and for importing the received synonym groups to corresponding synonym group lists;
a synonym group merging module for merging all synonym groups containing a same word into a new synonym group; and
a synonym group maintenance module for adding, deleting and/or modifying existing synonyms and/or synonym groups, and for updating a synonym group index.

2. The system according to claim 1, wherein each synonym group is a set of synonyms corresponding to an index word, each synonym being a word having the same or nearly the same meaning as another word or other words.

3. The system according to claim 1, wherein each synonym group list is a collection of synonym groups that corresponds to a category.

4. The system according to claim 4, wherein each synonym group list is comprised in a Microsoft Excel file.

5. The system according to claim 1, wherein the application server further comprises a word existence determination module for determining whether any word in a received synonym group already exists in the synonym group list that corresponds to a selected category.

6. The system according to claim 1, wherein the synonym group merging module is also for deleting any one or more of the synonym groups containing the same word after merging.

7. The system according to claim 1, wherein the application server further comprises a synonym group displaying module for displaying synonym group indexes, for selecting an index word from a synonym group index, and for displaying all synonym groups containing the selected index word and a corresponding category of each synonym group simultaneously.

8. A thesaurus maintaining method comprising the steps of:
selecting a category for importing a synonym group;
receiving a synonym group input by a user;
determining whether any word in the received synonym group already exists in a synonym group list that corresponds to the selected category;
importing the synonym group in the synonym group list that corresponds to the selected category if none of the words in the received synonym group can be found in the synonym group list; and
adding, deleting and/or modifying existing synonyms and/or synonym groups.

9. The thesaurus maintaining method according to claim 8, further comprising the step of displaying the synonym groups containing a same word as a word in the received synonym group if the word in the received synonym group already exists in the synonym group list.

10. The thesaurus maintaining method according to claim 9, further comprising the step of determining whether it is necessary to merge the displayed synonym groups into a new synonym group.

11. The thesaurus maintaining method according to claim 10, further comprising the step of merging the displayed synonym groups into a new synonym group if it is necessary to merge the displayed synonym groups into a new synonym group.

12. The thesaurus maintaining method according to claim 11, further comprising the step of importing the new merged synonym group to the synonym group list.

13. The thesaurus maintaining method according to claim 8, further comprising the step of determining whether there is any other synonym group input by the user for importing.

14. The thesaurus maintaining method according to claim 8, wherein the step of adding, deleting and/or modifying existing synonyms and/or synonym groups further comprises the step of selecting a category and displaying a synonym group index of the synonym group list that corresponds the selected category.

15. The thesaurus maintaining method according to claim 8, wherein the step of adding, deleting and/or modifying existing synonyms and/or synonym groups further comprises the step of selecting an index word from the displayed synonym group index.

16. The thesaurus maintaining method according to claim 8, wherein the step of adding, deleting and/or modifying existing synonyms and/or synonym groups further comprises the step of displaying all synonym groups containing the selected index word separately and a corresponding category of each synonym group simultaneously.

17. The thesaurus maintaining method according to claim 8, wherein the step of adding, deleting and modifying existing synonyms and/or synonym groups further comprises the step of updating the synonym group index.

18. A thesaurus maintaining method comprising the steps of:
selecting a category for importing a synonym group;
receiving a synonym group input by a user;
determining whether any word in the received synonym group already exists in a synonym group list that corresponds to the selected category;
importing the synonym group in the synonym group list that corresponds to the selected category only if none of the words in the received synonym group can be found in the synonym group list or merging into the existing synonym group is improper; and
adding, deleting and/or modifying at least one of existing synonyms and synonym groups.
